(19) United States
(12) Patent Application Publication
(10) Pub. No.: US 2020/0293034 A1
(43) Pub. Date: Sep. 17, 2020

(54) VEHICLE CONTROLS FOR AUTONOMOUS VEHICLES

(71) Applicant: GM GLOBAL TECHNOLOGY OPERATIONS LLC, Detroit, MI (US)

(72) Inventors: Jonathan T. Shibata, Whitmore Lake, MI (US); Paul A. Kilmurray, Wixom, MI (US); Krunal P. Patel, South Lyon, MI (US); David H. Vu, East Lansing, MI (US); Vukasin Denic, Ann Arbor, MI (US); Adam J. Heisel, South Lyon, MI (US); Mohsen Mehdizade, Toronto (CA)

(73) Assignee: GM GLOBAL TECHNOLOGY OPERATIONS LLC, Detroit, MI (US)

(21) Appl. No.: 16/351,851

(22) Filed: Mar. 13, 2019

(51) Int. Cl. G05D 1/00; G05D 1/02

(52) U.S. Cl. CPC G05D 1/0016; G05D 2201/0213; G05D 1/021

(57) ABSTRACT

Methods and apparatus are provided for controlling an autonomous vehicle. The control device includes an interface that establishes a connection to an autonomous vehicle, a processor that processes inputs and generates control commands to control at least one function of the autonomous vehicle, and an input arrangement with at least one control element that is assigned to a function of the autonomous vehicle. The control device transitions a controller of the autonomous vehicle to operate in at least one of a first remote operation mode and a second remote operation mode in which the autonomous vehicle is controlled by the control device, when the control device is connected to the autonomous vehicle via the interface. At least one function of a scope of functions of the autonomous vehicle is restricted in the first remote operation mode and the second remote operation mode.

The description generally relates to controlling autonomous vehicles. More particularly, the description relates to systems and methods for controlling an autonomous vehicle with an auxiliary control device where the autonomous vehicle is not movable because of failed sensors or because the sensors are not reliable.

For autonomous vehicles built without conventional controls there exist use cases such as plant manufacturing, vehicle shipping, service hubs among others where autonomous operation is not allowed or possible. For example, failures to autonomous computers or sensors would prevent the vehicle operating in autonomous mode. If the base functionality consisting of steering, brakes and propulsion are not impacted then using an operator with an auxiliary controller will be desired to move the vehicle, for example, between work stations.

Accordingly, it is desirable to allow an auxiliary controller to command at least one or more/all of propulsion, gear shift, braking and steering to enable moving the autonomous vehicle into garage areas or the like. Operators can then control vehicle speed, steering, gear shifts and electric parking brake through these controls to deliver the vehicle to the desired location. Furthermore, other desirable features and characteristics of the present invention will become apparent from the subsequent detailed description and the appended claims, taken in conjunction with the accompanying drawings and the foregoing technical field and background.

### SUMMARY

Apparatuses and methods for controlling an autonomous vehicle are provided. In one embodiment, the apparatus is a control device for controlling an autonomous vehicle and includes an interface that is configured to establish a connection to the autonomous vehicle, a processor that is configured to process inputs and generate control commands to control at least one function of the autonomous vehicle, and an input arrangement with at least one control element that is assigned to a function of the autonomous vehicle. When being connected to the autonomous vehicle via the interface, the control device transitions a controller of the autonomous vehicle to operate in at least one of a first remote operation mode and a second remote operation mode in which the autonomous vehicle is controlled by the control device. When operating in the first remote operation mode or the second remote operation mode, at least one function of a scope of functions of the autonomous vehicle is restricted.

In various embodiments, the at least one function of the scope of functions of the autonomous vehicle is one of: propulsion and brakes, gear, steering, electric parking brake, horn, wipers, hazard lights.

In various embodiments, the control device is configured to control the autonomous vehicle during or between executing tests of the autonomous vehicle, wherein for each one of the tests, at least one of a steering angle or a maximum velocity of the autonomous vehicle or a reaction rate of commands for controlling the autonomous vehicle is restricted.

In various embodiments, the interface is configured to establish a wired connection to the autonomous vehicle.

In various embodiments, when operating in the first remote operation mode or the second remote operation mode a maximum velocity of the autonomous vehicle is limited, wherein when operating in the first operation mode, the maximum velocity is limited to a value that is higher than the maximum velocity in the second operation mode.

In various embodiments, the control device is configured to limit a vehicle speed based on a steer angle of a steering system of the autonomous vehicle.

In various embodiments, at least one control element of the input arrangement is one of: acceleration/brake control, steering control, horn control, windshield wiper control, park brake control, and gear shift control.

In various embodiments, the control device further comprises an indicator arrangement with at least one indicator element, wherein the indicator arrangement is configured to indicate a state of at least one function of the autonomous vehicle.

In various embodiments, the at least one indicator element is one of: a power indicator, a forward indicator, a reverse indicator, a malfunction indicator, and a park brake indicator.

In various embodiments, the processor is configured to execute health and function monitoring of the control device when the control device is connected to the autonomous vehicle and to generate control commands for the autonomous vehicle when the health and function monitoring of the control device reports no malfunction of the control device.

A method is provided for controlling an autonomous vehicle with a control device during or between end-of-line or maintenance operations of the autonomous vehicle. The method includes the steps of establishing a connection between the control device and the autonomous vehicle; generating, by a processor of the control device, control commands based on an input to the control device to control at least one function of the autonomous vehicle; instructing, by a controller of the autonomous vehicle, an actuator system of the autonomous vehicle to execute the control commands; and controlling the autonomous vehicle during or before or after at least one of end-of-line or maintenance operations, wherein the end-of-line or maintenance operations are one of a static vehicle test, an alignment vehicle test, a dynamic vehicle test, a squeak and rattle test, a loading onto a vehicle carrier, a maneuvering of the autonomous vehicle.

In various embodiments, the method further comprises executing health and function monitoring of the control device after establishing the connection to the autonomous vehicle and generating commands for controlling of the autonomous vehicle by the control device when no malfunction of the control device is detected.

In various embodiments, the method further comprises authenticating the control device after establishing the connection to the autonomous vehicle, and accepting, by the autonomous vehicle, control commands when an authentication process of the control device is successful, wherein the control commands relate to at least one of: control propulsion and brakes, control gear, control steering, control parking brake.

In various embodiments, the method further comprises executing, by the controller of the autonomous vehicle and if the authentication process is not successful, at least one of: apply brakes, horn alert, bring the autonomous vehicle to a safe state.

In various embodiments, the method further comprises checking, by the controller of the autonomous vehicle, a status of a steering rack of the autonomous vehicle, and controlling the autonomous vehicle in accordance with the control commands received from the control device when the status of the steering rack is successfully checked; generating, by a manufacturing test tool, test commands for the autonomous vehicle in a first test station and transmitting the test commands to the autonomous vehicle; commanding the autonomous vehicle by the control device to exit the first test station and drive to a second test station; wherein, when commanding the autonomous vehicle to exit the first test station and driving to the second test station, the velocity of the autonomous vehicle is limited to a predetermined value.

In various embodiments, the method further comprises ignoring, by the controller of the autonomous vehicle, at least some of the control commands from the control device when the autonomous vehicle receives the test commands from the manufacturing test tool.

In various embodiments, some of the functions of the autonomous vehicle are controlled by the test commands of the manufacturing test tool while other functions of the autonomous vehicle are controlled by the control commands of the control device.

In various embodiments, the first test station is one of a static vehicle test station, an alignment vehicle test station, a dynamic vehicle test station, a squeak and rattle test station, and wherein the second test station is another one thereof.

In various embodiments, the method further comprises transitioning the controller of the autonomous vehicle to a fine control mode, wherein in the fine control mode, a sensitivity of at least one of steering, propulsion, and braking of the autonomous vehicle is varied to customize controls of the autonomous vehicle.

A system is provided, comprising an autonomous vehicle and a control device that is connected to the autonomous vehicle and configured to transmit control commands to control at least one function of a scope of functions of the autonomous vehicle. The control device comprises an interface that establishes a connection to the autonomous vehicle; a processor configured to process inputs and generate control commands to control the at least one function of the autonomous vehicle; and an input arrangement with at least one control element that is assigned to one of the at least one function of the autonomous vehicle. The control device is configured to transition a controller of the autonomous vehicle to operate in at least one of a first remote operation mode and a second remote operation mode in which the autonomous vehicle is controlled by the control device, wherein when operating in the first remote operation mode or the second remote operation mode, the at least one function of the scope of functions of the autonomous vehicle is restricted.

### BRIEF DESCRIPTION OF THE DRAWINGS

The exemplary embodiments will hereinafter be described in conjunction with the following drawing figures, wherein like numerals denote like elements, and wherein:

FIG. 1 schematically shows a system with an autonomous vehicle and a control device in accordance with an embodiment;

FIG. 2 schematically shows a controller of an autonomous vehicle in accordance with an embodiment;

FIG. 3 schematically shows a system in accordance with an embodiment;

FIG. 4 schematically shows a control device in accordance with an embodiment;

FIG. 5 schematically shows the process of connecting a control device to an autonomous vehicle in accordance with an embodiment;

FIG. 6 schematically shows the process of authenticating a control device by an autonomous vehicle in accordance with an embodiment;

FIG. 7 schematically shows the process of controlling an autonomous vehicle by a control device in accordance with an embodiment;

FIG. 8 schematically shows the process of controlling propulsion and brakes of an autonomous vehicle by a control device in accordance with an embodiment;

FIG. 9 schematically shows the process of controlling gear of an autonomous vehicle by a control device in accordance with an embodiment;

FIG. 10 schematically shows the process of controlling an autonomous vehicle by a control device in accordance with an embodiment;

FIG. 11 schematically shows the process of controlling the parking brake of an autonomous vehicle by a control device in accordance with an embodiment; and

FIG. 12 schematically shows the steps of a method for controlling an autonomous vehicle with a control device in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

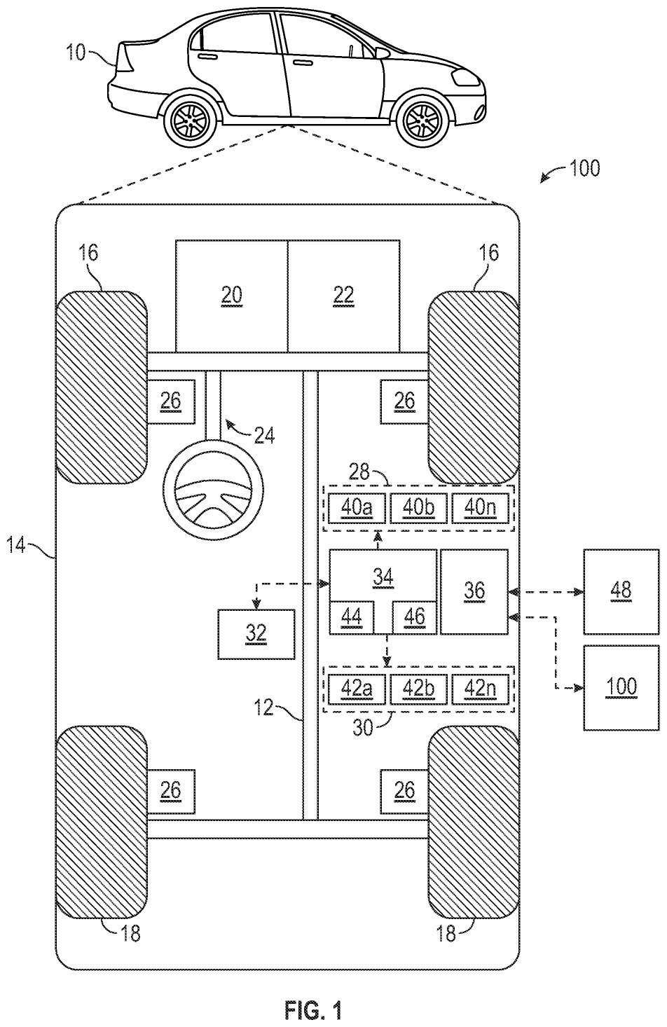

With reference to FIG. 1, a vehicle 10 is shown in accordance with various embodiments. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14.

In various embodiments, the vehicle 10 is an autonomous vehicle. The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 an 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, windshield wipers, horn, etc. (not numbered).

The communication system 36 is configured to wirelessly communicate information to and from other entities 48, such as but not limited to, other vehicles (“V2V” communication,) infrastructure (“V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system. For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

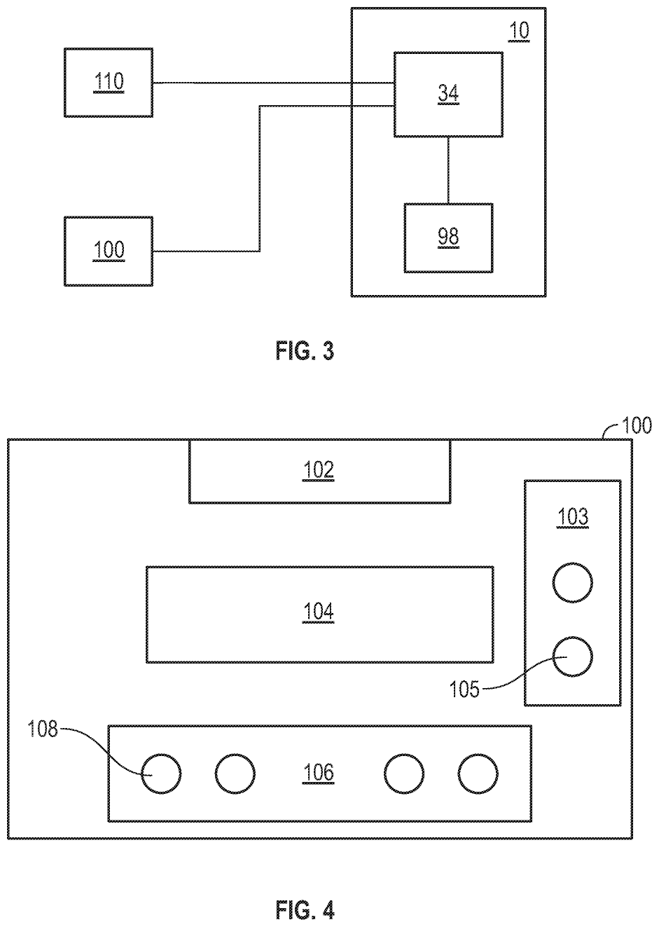

In various embodiments, one or more instructions of the controller 34 are embodied to facilitate controlling of at least one or more functions of the autonomous vehicle 10 by an auxiliary control device 100. In one embodiment, the control device 100 is connected to the vehicle 10 via the communication system 36. However, the control device 100 may be connected directly to the controller 34. The control device 100 and the controller 34 are configured so that the control device 100 controls at least one function of the vehicle 10. In one embodiment, the control device 100 and the vehicle 10 execute the steps of a method for controlling at least one function of the autonomous vehicle 10. The control device 100 is shown in more detail in FIG. 3 and details of the control device 100 are described below with reference to FIG. 3.

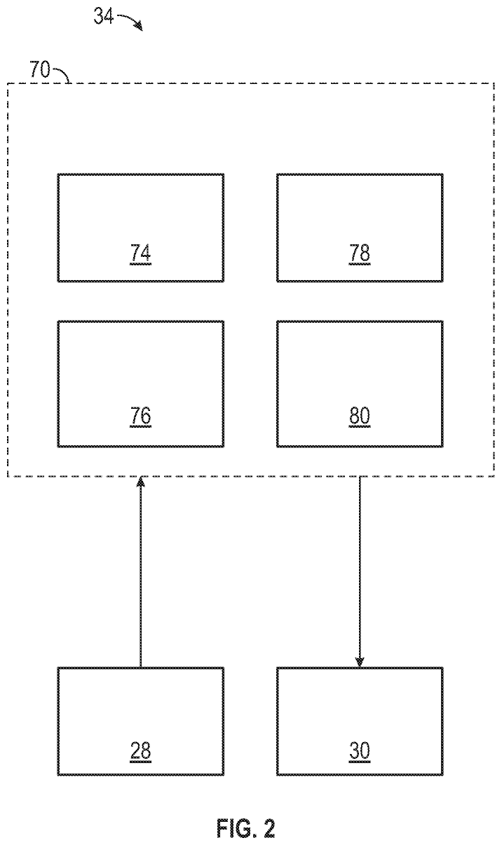

In accordance with various embodiments, controller 34 implements an autonomous driving system (ADS) 70 as shown in FIG. 2. That is, suitable software and/or hardware components of controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 2, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors. The computer vision system 74 may also be referred to as a sensor fusion system, as it fuses input from several sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

The vehicle control system 80 is configured to communicate a vehicle control output to the actuator system 30. In an exemplary embodiment, the actuators 42 include a steering control, a shifter control, a throttle control, and a brake control. The steering control may, for example, control a steering system 24 as illustrated in FIG. 1. The shifter control may, for example, control a transmission system 22 as illustrated in FIG. 1. The throttle control may, for example, control a propulsion system 20 as illustrated in FIG. 1. The brake control may, for example, control wheel brake system 26 as illustrated in FIG. 1.

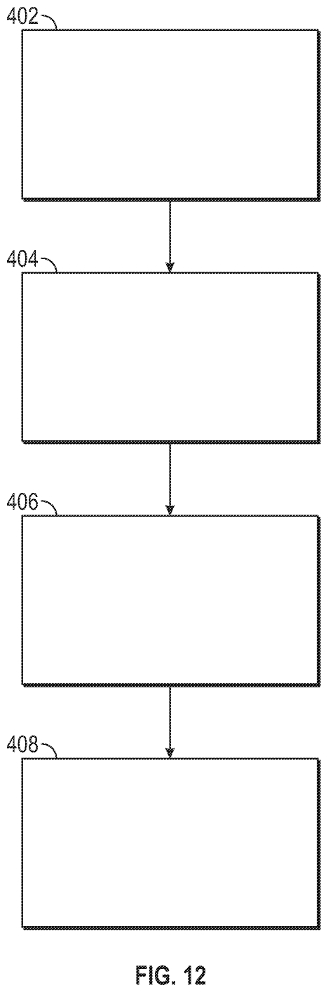

FIG. 3 schematically shows a vehicle 10 with a controller 34 and a terminate ride button 98. A control device 100 and a test tool 110 are connected to the controller 34 so that control commands (from the control device 100) and test commands (from the test tool 110) are transmitted to the controller 34 to control the vehicle 10 in a required or desired manner. The system shown in FIG. 3 is comprised of a control device 100 and an autonomous vehicle. The control device is implemented in accordance with one embodiment described herein, particularly with reference to FIG. 4. The system is configured to execute the method of various embodiments of the method described herein, particularly with reference to FIG. 12.

FIG. 4 shows in more detail the control device 100 already shown in FIG. 1 and FIG. 3. In one embodiment, the control device 100 comprises an interface 102, an indicator arrangement 103 having at least one indicator element 105, a processor 104, and an input arrangement 106 having at least one control element 108. The processor 104 can be any custom made or commercially available processor, a central processing unit (CPU), a graphics processing unit (GPU), an auxiliary processor among several processors, a semiconductor based microprocessor (in the form of a microchip or chip set), any combination thereof, or generally any device for executing instructions. The interface 102 is used to establish a connection to the autonomous vehicle 10. For example, the interface is used for a wire-based connection to another interface of the vehicle 10. However, the interface may also allow wireless connection between the control device 100 and the vehicle 10. The processor 104 processes inputs (like control commands for controlling functions of the vehicle 10) and generates control commands to control at least one function of the autonomous vehicle 10. The processor 104 receives the inputs for generating control commands from the input arrangement 106. The input arrangement 106 includes at least one control element 108 that is assigned to a function of the autonomous vehicle. For example, the input arrangement comprises control elements 108 for controlling acceleration/brake, steering left/right, safety interlock of input elements (control elements 108), horn, windshield wiper, park brake, direction select forward/reverse, and neutral transmission gear. Additional control elements for controlling any desired function of vehicle 10 may be provided. In this embodiment, the control device 100 is configured to, when being connected to the autonomous vehicle 10 via the interface 102, transition a controller 34 of the autonomous vehicle to operate in at least one of a first remote operation mode and a second remote operation mode in which the autonomous vehicle 10 is controlled by the control device 100, wherein when operating in the first remote operation mode or the second remote operation mode at least one function of a scope of functions of the autonomous vehicle is restricted. A restricted function means that the operation of the vehicle 10 is limited to a predetermined range of operation or within certain limits of the normal range of operation. For example, the maximum velocity of the vehicle 10 might be limited to a predetermined value when the controller 34 of the vehicle 10 is controlled by the control device. Furthermore, the maximum velocity might be further reduced when the steering system is commanded to a steering angle that is larger than a predetermined threshold value. In other words, in the first and second remote operation mode, the maximum velocity of the autonomous vehicle 10 is further reduced in a turn. Although reference is made to a first and a second remote operation mode of the controller 34 in this embodiment, this does not limit the number of remote operation modes. For example, there might be provided three or even more particular remote operation modes which can be selectively chosen by an operator who controls the control device when it is connected to the vehicle. Preferably, the control device 100 is used to control an autonomous vehicle that lacks at least one of conventional controls like steering wheel, brake pedal, accelerator pedal, or the like. However, the control device 100 can be used to control an autonomous vehicle that has such conventional controls. The control device can be used when located inside or outside the autonomous vehicle. Thus, an interface for connecting the control device to the autonomous vehicle can be located inside or outside the autonomous vehicle.

In one embodiment, the control device 100 is configured to control at least one of the following functions of the autonomous vehicle 10: propulsion and brakes, gear, steering, electric parking brake, horn, wipers, hazard lights.

In one embodiment, the control device 100 is configured to control the autonomous vehicle 10 during and/or between executing tests to the autonomous vehicle, wherein for each one of the tests, at least one of the following functions of the autonomous vehicle is restricted: steering angle, maximum velocity, reaction rate of the commands for controlling the autonomous vehicle.

In one embodiment, when operating in the first remote operation mode and the second remote operation mode the same at least one function of the scope of functions of the autonomous vehicle is restricted to a different value. For example, in the first remote operation mode, the maximum velocity is restricted to 20 kilometers per hour while in the second remote operation mode, the maximum velocity is restricted to 8 kilometers per hour or even to 2 kilometers per hour. Similar considerations apply to other functions of the vehicle 10.

In one embodiment, when operating in the first remote operation mode and the second remote operation mode a maximum velocity of the autonomous vehicle is limited, wherein when operating in the first operation mode, the maximum velocity is limited to a value that is higher than the maximum velocity in the second operation mode.

In one embodiment, the interface is configured to establish a detachable wired connection to the autonomous vehicle. For example, the control device 100 is connected to the vehicle 10 by using a cable with respective plugs for mechanically and communicatively connecting the cable to the control device 100 and to the vehicle 10.

In one embodiment, the control device is configured to limit the vehicle speed based on a steer angle of a steering system, i.e., of a steer angle of the steerable wheels. For example, a maximum speed of the vehicle is reduced when the steer angle of the steerable wheels is unequal to 0° or larger than a predetermined threshold, with 0° being equal to a longitudinal axis of the vehicle and driving straight forward. The threshold value of the steer angle might be between 1° and 5°, for example. When the threshold value is exceeded, the speed of the vehicle is limited. The speed of the vehicle can be dynamically limited to a decreasing value the larger the steer angle gets. In other words, the speed is limited to a lower value for narrow turns that are taken with greater values of the steer angle.

In one embodiment, the at least one control element of the input arrangement is one of: acceleration/brake control, steering control, horn control, windshield wiper control, park brake control, gear shift control.

In one embodiment, the control device further comprises an indicator arrangement with at least one indicator element, wherein the indicator arrangement is configured to indicate a state of at least one function of the autonomous vehicle. The indicator element may be an optical indicator with a light like an LED or any other suitable luminaire.

In one embodiment, the at least one indicator element is one of: a power indicator, a forward indicator, a reverse indicator, a malfunction indicator, a park brake indicator. Thus, the indicators are assigned to these functions of the vehicle 10.

Generally, the control device 100 may receive information about the status of the vehicle 10 via the interface 102. The connection between the interface 102 and the vehicle 10 may be a bidirectional communication connection for transmitting and receiving information. Control commands from processor 104 are transmitted to vehicle 10 while information about the status of the vehicle 10 and/or one or more of its functions are received via interface 102. The received information is forwarded to processor 104 which commands the indicator arrangement with its individual indicator elements to show the received status of vehicle 10.

In one embodiment, the processor 104 is configured to execute health and function monitoring of the control device 100 when the control device is connected to an autonomous vehicle 10 and to generate control commands for the autonomous vehicle only if the health and function monitoring of the control device reports no malfunction of the control device 100. Thus, it is ensured that the control device only takes over control of a function of the autonomous vehicle 10 when there is no malfunction of the control device. The health and function monitoring may include one of the following: verify proper functioning of the input arrangement, of the interface, of the connection between control device and vehicle, and of the indicator arrangement.

The control device 100 may comprise an energy source like a battery. Alternatively, the control device 100 may receive electrical energy from the autonomous vehicle 10 via the wire that connects the interface 102 to the vehicle 10.

The control device 100 is configured to monitor health and functioning of itself and of the vehicle 10. The control device 100 takes inputs from an operator by the input arrangement 106 and converts, by the processor 104, the inputs into vehicle motion commands. The control device enables safe and secure operation of the autonomous vehicles without conventional controls in service hubs, manufacturing plants and logistics situations where autonomous operation may be difficult or impossible. When vehicle health faults are detected, the vehicle 10 is brought to a stopped, secured state.

The controller 34 is configured to detect a connection between the vehicle 10 and the control device 100. As soon as control device 100 is connected to the vehicle 10 and the health monitoring of the control device 100 and of the vehicle 10 is successfully completed, the controller 34 transitions from its current mode of operation into a remote operation mode in which at least one function of the autonomous vehicle 10 is controlled by the control device 100. For example, the controller 34 might automatically detect the control device 100 once it is plugged into an interface of the vehicle.

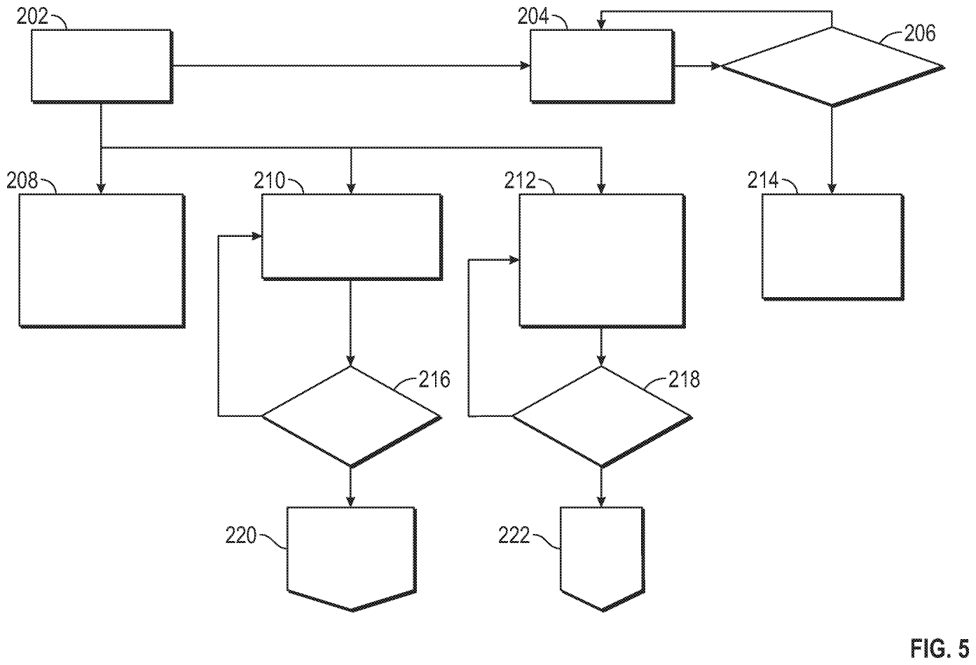

FIG. 5 schematically shows the process of connecting a control device 100 to an autonomous vehicle 10. The control device 100 is mechanically connected to the vehicle 10 in the first step 202. Thereafter, the communication between the control device 100 and the vehicle 10 is monitored and feedback information is displayed to an operator at step 208. After connecting the control device 100 to the vehicle 10, diagnostic switches are used to diagnose the control device 100 at step 204. Once the diagnostic is complete at step 206, control commands are enabled to be transmitted from the control device 100 to the vehicle 10, i.e., the commands from the input elements are used to generate control commands by the processor 104 and transmit the control commands to the vehicle 10 at step 214. After connecting the control device 100 to the vehicle 10 at step 202, a handshake procedure between the vehicle 10 and the control device 100 is carried out and monitored at step 210. When the handshake request from the vehicle is received by the control device 100 at step 216, cybersecurity information is transmitted between the control device 100 and the vehicle 10 to authenticate the connection at step 220. At step 212, the health of the control device 100 is monitored and redundant input rationality checks are carried out. If a fault is detected at step 218, the fault is reported to the vehicle 10 at step 222. When such a fault is received by the controller 34 of the vehicle 10, the vehicle 10 may be brought to a safe state, i.e., stop operation of the vehicle 10.

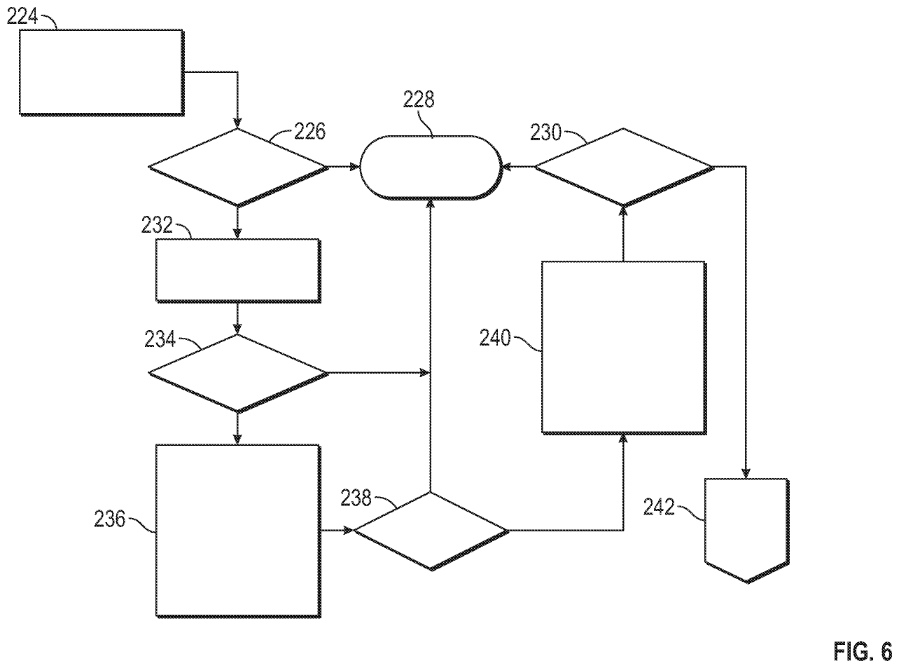

FIG. 6 schematically shows a process 224 of authenticating a control device 100 by an autonomous vehicle 10. This process 224 follows step 220 of FIG. 5. If the control device 100 is verified at step 226, a startup test is executed by diagnosing the device at step 232. When this test is passed at 234, safety criteria are checked at step 236: seatbelts, door, hood, hatch, terminate ride button 98, emergency stop button, safety interlock. If none of verification at step 226, diagnose startup at step 232, and safety criteria check at step 236 passed, motion of the vehicle 10 is inhibited at step 228. Once the safety criteria check at step 236 has passed at step 238, the vehicle health is monitored, preferably continuously monitored, at step 240. As long as the vehicle 10 is in condition for operation at step 230, control of the vehicle 10 by the control device 100 is enabled at step 240. Otherwise, motion of the vehicle 10 is inhibited at step 228.

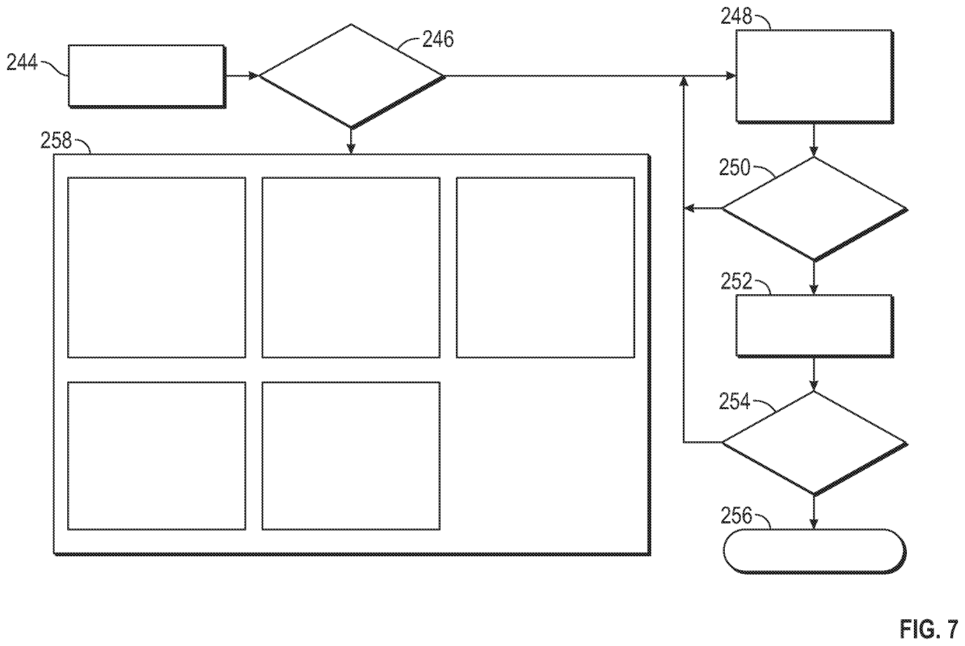

FIG. 7 schematically shows the process of controlling the autonomous vehicle 10 by the control device 100 following step 242 of FIG. 6. Safety and health of the vehicle 10 are continuously monitored at step 244. If the vehicle 10 is safe and healthy at step 246, control of functions of the vehicle 10 by the control device 100 is enabled. The control of the functions of the vehicle 10 is shown in box 258. The control device 100 may control at least one of the following functions of the vehicle 10: propulsion and brakes as a function of speed, steer angle, safety limits, rate limits, operator input; gear as a function of speed, grade, parking brake torque applied, operator input; steering as a function of speed, rate limit, system limit, operator input; parking brake as a function of speed, gear, operator input; and horn, wipers, hazard lights as a function of speed, gear, parking brake, operator input. If the vehicle 10 is not safe and healthy at step 246, brakes are applied at step 248 and a horn alert is initiated while steering of the vehicle 10 is still allowed. If the speed of the vehicle 10 is less than a predetermined threshold value at step 250, the vehicle 10 is commanded to park and to unlock doors at step 252. Otherwise, if speed is equal to or larger than the predetermined threshold value, the instructions of step 248 are applied until the speed is less than the threshold value. As soon as the vehicle 10 is stationary at step 254, control is released at step 256.

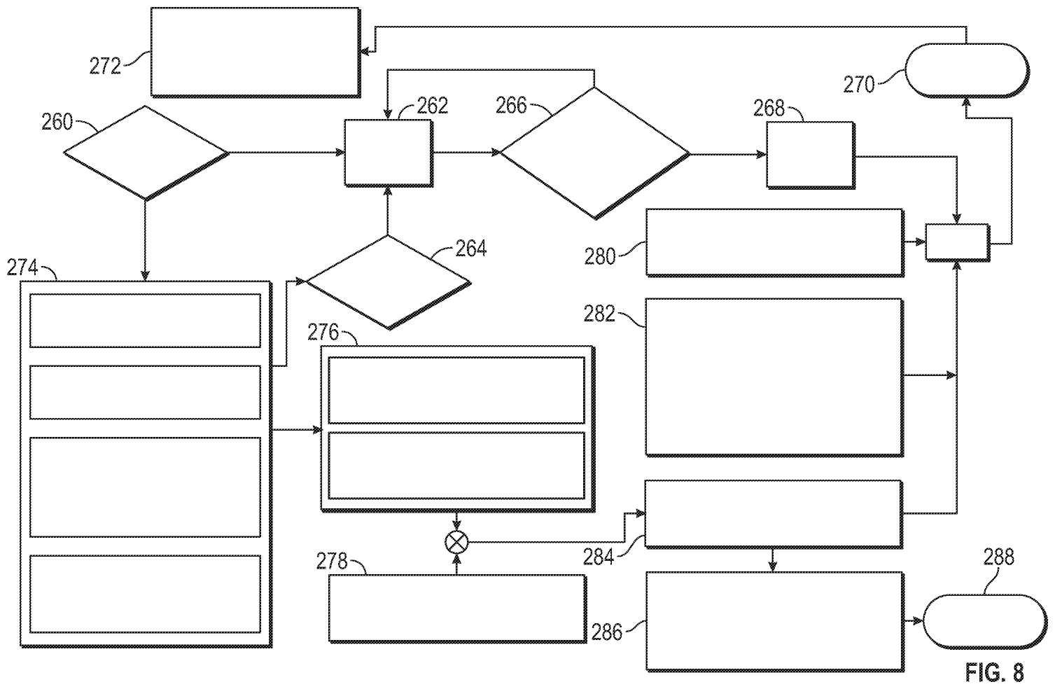

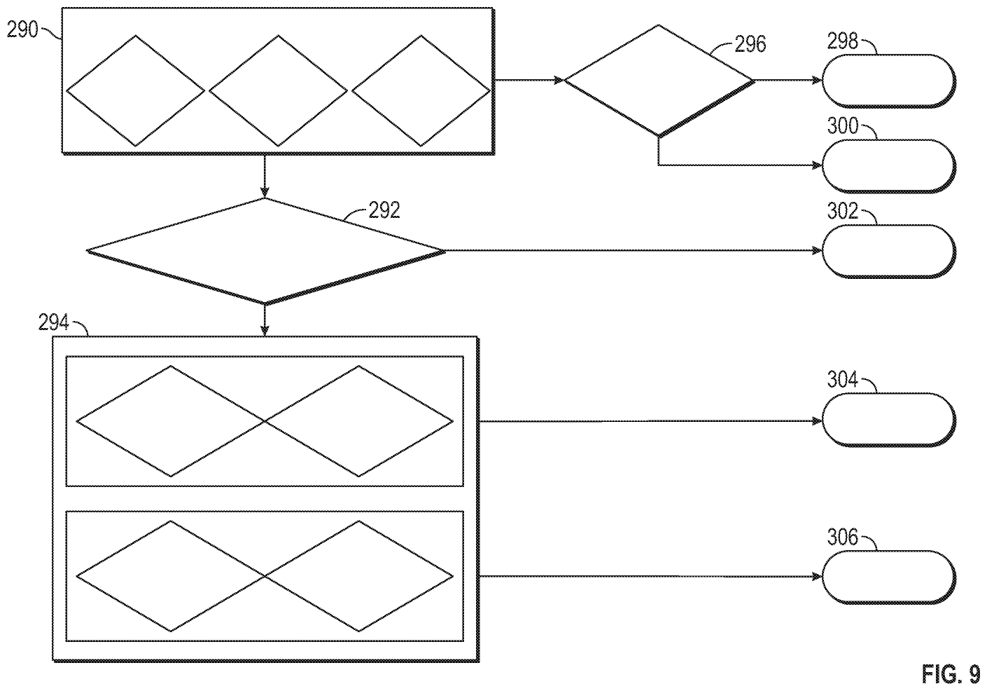

FIG. 8 schematically shows the process of controlling propulsion and brakes of the autonomous vehicle 10 by the control device 100. At step 260, it is determined if the park gear is engaged. If it is not, the vehicle 10 is controlled by the control device 100 at step 274. This controlling of the vehicle 10 comprises inversion of an input element (joystick inversion) as a function of the gear, selecting one of fine or high speed mode as a function of the an operator input, determine desired acceleration as a function of gear, speed, operator input, and determine a desired speed limit as a function of gear and steering. If during controlling of the vehicle 10 it is desired to stand still as shown at step 264, brakes are applied as shown at step 262 and it is determined if sufficient torque is applied for stand still at step 266. If there is not sufficient torque, the brake force may be increased at step 262, otherwise brakes are hold as shown at step 268. During controlling of the vehicle 10 at step 274, an acceleration error and correction is calculated, and acceleration is converted to torque at step 276. Based on a calculated road load as a function of speed at step 278, propulsion and brake are split at step 284. At step 282, grade brake compensation is calculated based on grade, gear, measured acceleration rationality check. At step 280, a rollback is determined as a function of gear and speed. The output values of steps 268, 280, 282, and 284 are accumulated to generate a brake command at step 270 which is applied to a brake rationality check being a function of gear, health, operator input at step 272. At step 286, a gradient and a propulsion torque is limited to safety limits, and finally, a propulsion command is generated at step 288.

FIG. 9 schematically shows the process of controlling gear of the autonomous vehicle 10 by a control device 100. At step 290, if a health fault or a safety fault or a park brake command is detected, at step 296 it is determined if the speed is lower than a predetermined threshold value. If the speed is lower than the threshold value, this results in a park command at step 298, otherwise the previous gear is held at step 300. If at step 290 none of a health fault or a safety fault or a park brake command is detected, at step 292 it is verified if a speed measurement fault applies. If so, neutral gear is commanded at step 302, otherwise it is determined at step 294 if either the park gear is selected and the brakes are applied in a first use case or if, in a second use case, the park gear is not selected and the speed is lower than a threshold value. If one of these applies, the operator command is applied at step 304, otherwise the previous gear is held at step 306.

The schemes shown in FIG. 5 to FIG. 9 are implemented by instructions executed by the processor 104 of the control device 100 and by the controller 34 of the vehicle 10.

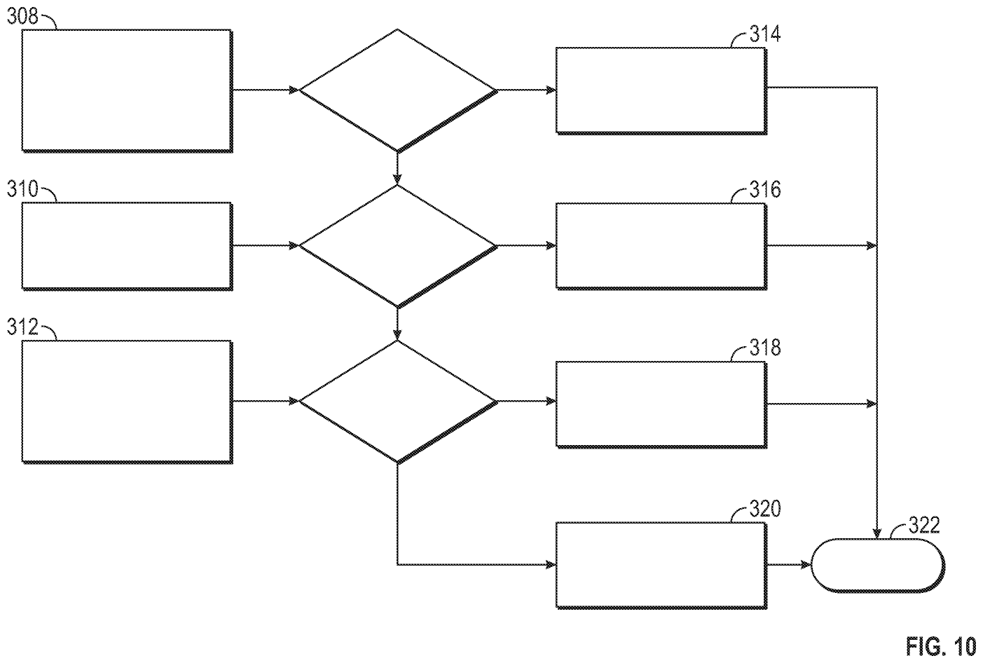

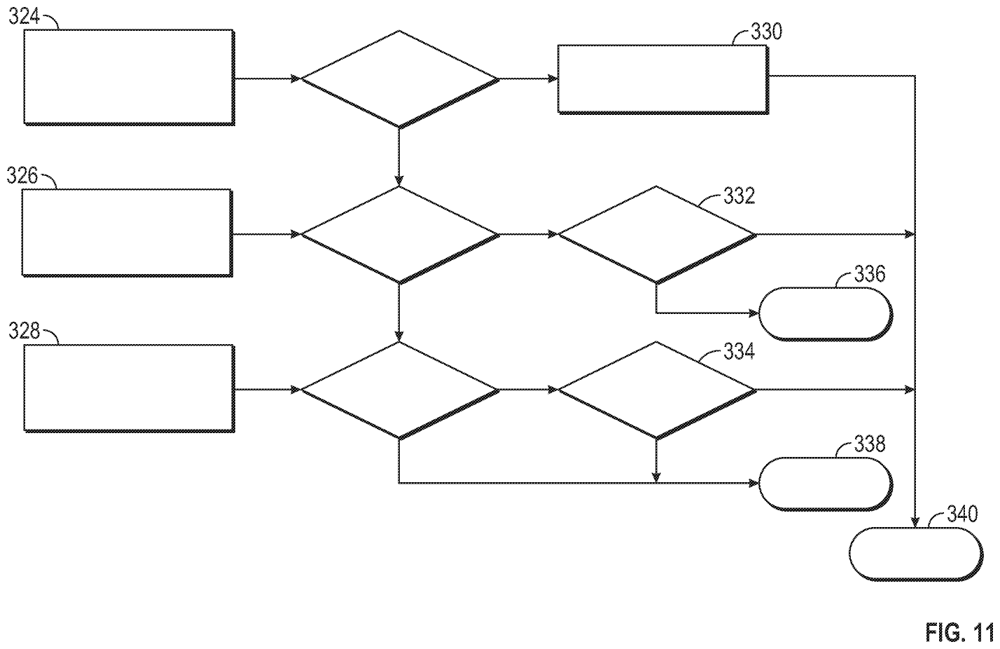

FIG. 10 schematically shows the process of controlling the autonomous vehicle 10 by the control device 100 during and between test procedures of the autonomous vehicle 10. At step 308, a factory end of line static vehicle test (SVT) mode is determined. If this mode applies, the SVT mode limit, rate limit, and desired angle are applied at step 314 and the steering is accordingly commanded at step 322. At step 310, an end of line dynamic vehicle test (DVT) mode is determined. If this mode applies, the DVT mode limit, rate limit, and desired angle are applied at step 316 and the steering is accordingly commanded at step 322. At step 312, an operator desired mode (e.g., one of high speed or fine control, described in more detail below) is determined. If the high speed mode is selected, a high speed mode limit, rate limit, and desired angle are applied at step 318, otherwise a fine control mode limit, rate limit, and desired angle are applied at step 320, and the steering is accordingly commanded at step 322.

The scheme shown in FIG. 10 is implemented by the processor 104 of the control device 100 in combination with the controller 34 of the vehicle 10. The scheme is described in more detail with reference to FIG. 12 and the embodiments of the method for controlling the autonomous vehicle 10 with an auxiliary control device 100.

FIG. 11 schematically shows the process of controlling the parking brake of the autonomous vehicle 10 by the control device 100. At step 324, a factory end of line vehicle test mode is determined. If the test mode applies, the test tool request is followed at step 330 and the park brake command is generated at step 340. At step 326 it is determined if the safety and health mode allows the park brake to apply. If it is allowed and there is an operator request at step 332 to apply the park brake, the park brake command is generated at step 340. If no operator request exists at step 332, no park brake command is generated at step 336. At step 328 it is determined if the safety and health mode allows the park brake to release. If this is allowed and there is an operator request at step 334 to release the park brake, the respective park brake command is generated at step 340. If no operator request exists at step 334 to release the park brake, no park brake command is generated at step 338.

FIG. 12 schematically shows the steps of a method for controlling an autonomous vehicle 10 with an auxiliary control device 100.

In one embodiment, the method for controlling an autonomous vehicle 10 with a control device 100 during and/or between end-of-line or maintenance operations of the autonomous vehicle 10 comprising the steps: establishing a connection between the control device 100 and the autonomous vehicle 10 at step 402; generating, by a processor 104 of the control device 100, control commands based on an input to the control device 100 to control at least one function of the autonomous vehicle 10 at step 404; instructing, by a controller 34 of the autonomous vehicle 10, an actuator system 30 of the autonomous vehicle 10 to execute the control commands at step 406; and controlling the autonomous vehicle 10 during and/or before and/or after at least one of the following end-of-line or maintenance operations: static vehicle test, alignment vehicle test, dynamic vehicle test, squeak and rattle test, loading onto vehicle carrier, maneuvering of the autonomous vehicle 10 at step 408.

The principles of this method are basically also described with reference to FIG. 10. These algorithms customize the vehicle response for each end of line test (SVT, AVT, DVT and Squeak and Rattle Testing), normal operation and fine control mode (for loading the vehicle on a car hauler, for example). The normal operation, fine control, high speed mode are different modes of operation to which the controller 34 of vehicle 10 can be transitioned when connecting the control device 100 to the vehicle 10. For example, one of these modes can be selectively chosen by an operator using the control device 100. When one of these modes is chosen, the vehicle 10 is controlled and commanded by the control device 100 in accordance with the restrictions that apply in the respective mode of operation.

The first end of line test is static vehicle test. Here, the control algorithm of the controller 34 checks the status of the steering rack learn and will not allow the control device 100 to be used until the check of the steering rack is complete. In the SVT, when the manufacturing test tool 110 (FIG. 3) is connected to the vehicle 10 and commands a steering rack learn, the algorithm of the controller 34 commands a sweep from one end stop to the other. The manufacturing end of line test tool 110 is connected to the vehicle 10 in the end of line test stations to request the mode (SVT, AVT or DVT) as well as other functions. The manufacturing test tool 110 can be separate from the control device 100. For example, the end of line manufacturing test tool 110 requests that a steering sweep be performed. The control algorithm of the controller 34 of the vehicle 10 executes the sweep.

The controller 34 monitors the health of the vehicle 10 and a built in terminate ride button 98 and exits the test if a fault or operator request to stop is detected. Once this is complete, the vehicle 10 is allowed to listen to commands generated and transmitted by the control device 100.

After completion of the static vehicle test, the vehicle 10 is moved by using the control device 100 in the normal remote operation mode of the controller 34. In this normal remote operation mode, the speed is limited to 8 kilometers per hour.

For executing the alignment vehicle test (AVT), the vehicle 10 is loaded onto chassis dynamometer using the control device 100 in normal remote operation mode. When the test tool 110 is connected and requests the alignment test to be performed, the controller 34 ignores the commands from the control device 100 and commands the actuator devices 42a-42n of the vehicle 10 to be set for the test. These setting are transmission gear to neutral, electric parking brake to off, and the steering angle to zero to apply torque to hold this position. The operator adjusts the alignment of the vehicle 10 in a manual operation, e.g., by adjusting the tie rod length. When the test is complete and the chassis dynamometer has stopped, the algorithm of the controller 34 puts the transmission into park gear to secure the vehicle 10 in a stationary position.

Subsequently, the vehicle 10 is moved via the control device 100 using the normal remote operation mode to the dynamic vehicle test (DVT) station. In this mode the speed is limited to 8 kilometers per hour, kph.

In the DVT station, the vehicle 10 is loaded onto chassis dynamometer using the control device 100 in normal remote operation mode. When the test tool 110 is connected to the vehicle 10 and requests the dynamic vehicle test, the algorithm of the controller 34 ignores the transmission, propulsion and braking requests generated and transmitted from the control device 100. The algorithm of the controller 34 customizes the steering response to the control device 100 to allow the operator to smoothly control the vehicle 10 on the chassis dynamometer by using the control device 100. In DVT mode, the algorithm of the controller 34 uses the propulsion and braking commands from the end of line test tool 110 but uses the steering commands from the control device 100. So, propulsion and braking commands from the control device 100 is ignored, but the steering is applied. This is done by reducing the steering authority, i.e., maximum steer angle, and response speed, i.e., rate of change of steer angle. The algorithm of the controller 34 puts the transmission into forward gear. The test tool 110 sends a combination of torque commands and desired speeds. The algorithm of the controller 34 controls the vehicle speed to the commanded set point (roughly 80 kph). The transmission is shifted to neutral gear by the controller 34. The test tool requests the brake tests to be performed. The controller 34 sends a brake command to each individual wheel 16, 18 to check performance. The algorithm of controller 34 then sends a brake command to all wheels 16, 18 to check system capability. The wheels 16, 18 are then brought to rest and the algorithm of the controller 34 puts the transmission into park gear to secure the vehicle 10 in a stationary position.

The controller 34 monitors the health of the vehicle 10 and the built in terminate ride button 98 throughout the test. It will exit the test if a fault or operator request to stop is detected. If the wheels 16, 18 are in motion during a fault or operator requested stop, the vehicle 10 will apply a low level of braking to bring the wheels 16, 18 to a stop and prevent hard braking which could cause the vehicle 10 to jump off of the chassis dynamometer.

Subsequently, the vehicle 10 is moved via the control device 100 using the normal remote operation mode to the squeak and rattle test. The vehicle 10 is put into high speed mode by an input element 108 (e.g., switch) on the control device 100 in order to complete the squeak and rattle testing. In high speed mode while moving forward in a straight line, the speed is allowed up to 20 kph. The speed allowed in a turn is 8 kph, so the controller 34 controls the vehicle speed based on steering wheel angle and control device 100 command of steering angle.

Finally, the vehicle 10 is loaded onto a vehicle hauler. The input elements 108 (switches) on the control device 100 are used to set the controller 34 into low speed mode. The algorithm of the controller 34 changes the sensitivity of the steering, propulsion and braking to customize the controls to the loading environment. Finer control of the steering is required, and the maximum range of road wheel angle needed is very small. The low speed mode recalibrates the steering to allow for this adjustment. The speed is also controlled to a very low speed (for example 1-2 kph). The algorithm of controller 34 controls to this very low speed while providing enough torque to ascend the ramps of the vehicle hauler.

Although the examples above are provided with reference to an end of line test, the control device 100 can be used to control the autonomous vehicle 10 in any desired area or region.

In one embodiment, the method further comprises executing, by the controller 34 of vehicle 10, health and function monitoring of the control device 100 after establishing the connection to the autonomous vehicle 10 and generating commands for controlling of the autonomous vehicle 10 by the control device 100 when no malfunction of the control device is detected.

In one embodiment, the method further comprises authenticating, by the controller 34, the control device 100 after establishing the connection to the autonomous vehicle 10, and accepting, by the autonomous vehicle 10, control commands when an authentication process of the control device 100 is successful, wherein the control commands relate to at least one of: control propulsion and brakes, control gear, control steering, control parking brake.

In one embodiment, the method further comprises executing, by the controller 34 of the autonomous vehicle 10, at least one of the following functions if the authentication process is not successful: apply brakes, horn alert, bring the autonomous vehicle to a safe state.

In one embodiment, the method further comprises checking, by the controller 34 of the autonomous vehicle 10, a status of a steering rack of the autonomous vehicle 10, and steering the autonomous vehicle 10 in accordance with the control commands received from the control device 100 once the status of the steering rack is successfully checked; generating, by a manufacturing test tool 110, test commands for the autonomous vehicle 10 in a first test station and transmitting the test commands to the autonomous vehicle 10; and commanding the autonomous vehicle 10 by the control device 100 to exit the first test station and drive to a second test station, wherein, when commanding the autonomous vehicle 10 to exit the first test station and driving to the second test station, the velocity of the autonomous vehicle 10 is limited to a predetermined value.

In one embodiment, the method further comprises ignoring, by the controller 34 of the autonomous vehicle 10, at least some of the control commands from the control device 100 while the autonomous vehicle 10 receives test commands from the manufacturing test tool 110.

In one embodiment, some of the autonomous vehicle functions are controlled by test commands of the manufacturing test tool 110 while other autonomous vehicle functions are controlled by control commands of the control device 100.

In one embodiment, the first test station is one of a static vehicle test station, an alignment vehicle test station, a dynamic vehicle test station, a squeak and rattle test station, and the second test station is another one thereof.

In one embodiment, the method further comprises transitioning the controller 34 of the autonomous vehicle 10 to a fine control mode, wherein in the fine control mode, a sensitivity of at least one of steering, propulsion, and braking of the autonomous vehicle is varied to customize the controls of the autonomous vehicle.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A control device for controlling an autonomous vehicle, the control device comprising:
an interface configured to establish a connection to the autonomous vehicle;
a processor configured to process inputs and generate control commands to control at least one function of the autonomous vehicle; and
an input arrangement with at least one control element that is assigned to a function of the autonomous vehicle;
wherein the control device is configured to, when being connected to the autonomous vehicle via the interface, transition a controller of the autonomous vehicle to operate in at least one of a first remote operation mode and a second remote operation mode in which the autonomous vehicle is controlled by the control device;
wherein when operating in the first remote operation mode or the second remote operation mode at least one function of a scope of functions of the autonomous vehicle is restricted.

2. The control device of claim 1,
wherein the at least one function of the scope of functions of the autonomous vehicle is one of: propulsion and brakes, gear, steering, electric parking brake, horn, wipers, hazard lights.

3. The control device of claim 1,
wherein the control device is configured to control the autonomous vehicle during or between executing tests of the autonomous vehicle;
wherein for each one of the tests, at least one of a steering angle or a maximum velocity of the autonomous vehicle or a reaction rate of commands for controlling the autonomous vehicle is restricted.

4. The control device of claim 1,
wherein the interface is configured to establish a wired connection to the autonomous vehicle.

5. The control device of claim 1,
wherein when operating in the first remote operation mode or the second remote operation mode a maximum velocity of the autonomous vehicle is limited;
wherein when operating in the first operation mode, the maximum velocity is limited to a value that is higher than the maximum velocity in the second operation mode.

6. The control device of claim 1,
wherein the control device is configured to limit a vehicle speed based on a steer angle of a steering system of the autonomous vehicle.

7. The control device of claim 1,
wherein the at least one control element of the input arrangement is one of: acceleration/brake control, steering control, horn control, windshield wiper control, park brake control, and gear shift control.

8. The control device of claim 1,
further comprising an indicator arrangement with at least one indicator element;
wherein the indicator arrangement is configured to indicate a state of at least one function of the autonomous vehicle.

9. The control device of claim 8,
wherein the at least one indicator element is one of: a power indicator, a forward indicator, a reverse indicator, a malfunction indicator, and a park brake indicator.

10. The control device of claim 1,
wherein the processor is configured to execute health and function monitoring of the control device when the control device is connected to the autonomous vehicle and to generate control commands for the autonomous vehicle when the health and function monitoring of the control device reports no malfunction of the control device.

11. A method for controlling an autonomous vehicle with a control device during or between end-of-line or maintenance operations of the autonomous vehicle, the method comprising the steps:
establishing a connection between the control device and the autonomous vehicle;
generating, by a processor of the control device, control commands based on an input to the control device to control at least one function of the autonomous vehicle;
instructing, by a controller of the autonomous vehicle, an actuator system of the autonomous vehicle to execute the control commands;
controlling the autonomous vehicle during or before or after at least one of end-of-line or maintenance operations, wherein the end-of-line or maintenance operations are one of a static vehicle test, an alignment vehicle test, a dynamic vehicle test, a squeak and rattle test, a loading onto a vehicle carrier, a maneuvering of the autonomous vehicle.

12. The method of claim 11, further comprising:
executing health and function monitoring of the control device after establishing the connection to the autonomous vehicle and generating commands for controlling of the autonomous vehicle by the control device when no malfunction of the control device is detected.

13. The method of claim 11, further comprising:
authenticating the control device after establishing the connection to the autonomous vehicle, and accepting, by the autonomous vehicle, control commands when an authentication process of the control device is successful, wherein the control commands relate to at least one of: control propulsion and brakes, control gear, control steering, control parking brake.

14. The method of claim 13, further comprising:
executing, by the controller of the autonomous vehicle and if the authentication process is not successful, at least one of: apply brakes, horn alert, bring the autonomous vehicle to a safe state.

15. The method of claim 11, further comprising:
checking, by the controller of the autonomous vehicle, a status of a steering rack of the autonomous vehicle, and controlling the autonomous vehicle in accordance with the control commands received from the control device when the status of the steering rack is successfully checked;
generating, by a manufacturing test tool, test commands for the autonomous vehicle in a first test station and transmitting the test commands to the autonomous vehicle;
commanding the autonomous vehicle by the control device to exit the first test station and drive to a second test station;
wherein, when commanding the autonomous vehicle to exit the first test station and driving to the second test station, the velocity of the autonomous vehicle is limited to a predetermined value.

16. The method of claim 15, further comprising:
ignoring, by the controller of the autonomous vehicle, at least some of the control commands from the control device when the autonomous vehicle receives the test commands from the manufacturing test tool.

17. The method of claim 16,
wherein some of the functions of the autonomous vehicle are controlled by the test commands of the manufacturing test tool while other functions of the autonomous vehicle are controlled by the control commands of the control device.

18. The method of claim 15,
wherein the first test station is one of a static vehicle test station, an alignment vehicle test station, a dynamic vehicle test station, a squeak and rattle test station, and wherein the second test station is another one thereof.

19. The method of claim 11, further comprising:
transitioning the controller of the autonomous vehicle to a fine control mode;
wherein in the fine control mode, a sensitivity of at least one of steering, propulsion, and braking of the autonomous vehicle is varied to customize controls of the autonomous vehicle.

20. A system, comprising:
an autonomous vehicle;
a control device that is connected to the autonomous vehicle and configured to transmit control commands to control at least one function of a scope of functions of the autonomous vehicle;
wherein the control device comprises:
an interface that establishes a connection to the autonomous vehicle;
a processor configured to process inputs and generate control commands to control the at least one function of the autonomous vehicle; and
an input arrangement with at least one control element that is assigned to one of the at least one function of the autonomous vehicle;
wherein the control device is configured to transition a controller of the autonomous vehicle to operate in at least one of a first remote operation mode and a second remote operation mode in which the autonomous vehicle is controlled by the control device;
wherein when operating in the first remote operation mode or the second remote operation mode, the at least one function of the scope of functions of the autonomous vehicle is restricted.
